(19) United States
(12) Patent Application Publication
(10) Pub. No.: US 2013/0210987 A1
(43) Pub. Date: Aug. 15, 2013

(54) SOLIDIFYING-AGENT COMPOSITION FOR SOIL BLOCKS

(71) Applicant: Ji Hoon Kim, Daegu (KR)

(72) Inventor: Ji Hoon Kim, Daegu (KR)

(21) Appl. No.: 13/809,301

(22) PCT Filed: Jul. 8, 2011
(86) PCT No.: PCT/KR11/05028

§ 371 Date: Jan. 9, 2013

(30) Foreign Application Priority Data
Jul. 9, 2010 (KR) 10-2010-0066187

(51) Int. Cl. C04B 16/06

(52) U.S. Cl. CPC C04B 16/0691
USPC 524/414

(57) ABSTRACT

The present invention relates to a solidifying-agent composition for soil blocks, and more particularly, to a solidifying-agent composition for soil blocks that comprise nylon fibers generated during crushing tires. The solidifying-agent composition of the present invention can be applied to soil blocks or to materials to be placed in a construction site, thus utilizing waste resources and preventing environmental contamination, and the soil blocks prepared using the solidifying-agent composition of the present invention exhibit excellent finishing performance, tensile strength, shock resistance, adhesive properties and resistance against exposure to alkali or ultraviolet rays.

### CROSS-REFERENCE TO RELATED APPLICATION

This application claims the benefit of Korean Patent Application No.10-2010-0066187, filed on Jul. 9, 2010 in the Korean Intellectual Property Office, the disclosure of which is incorporated herein by reference.

### TECHNICAL FIELD

The present invention relates to a solidifying agent composition for soil blocks, and to a solidifying agent composition for solid blocks comprising nylon fibers generated from crushed tires.

### BACKGROUND

In case where architectural and civil soil blocks are prepared, applied and paved without a separate baking using a conventional solidifying agent, there are problems that deformation or crack occurs when solidifying it at room temperature. As such, prior arts have attempted to prevent a crack by mixing rice straws, but the rice straws are rotten due to moisture after a long time and thus the issue of their durability has come to the fore.

As an alternative to resolve such problems, nylon fibers are desirable materials which comprise greater than 60% of the textile market for construction in advanced countries recently.

The nylon fibers are fibers of new concepts whose effect and performance have been proven to be superior to those of conventional fibers. Also, the nylon fibers have an excellent dispersability with a hydrophillic property. As such, no agglomeration phenomenon occurs and no hair exposure is made on their installation surface. Also, they have an excellent finishing performance as well as excellent tensile strength and impact resistance. Further, since the nylon fibers themselves have about 4% of absorption rate, the adhesion force with cements increases and they are effective in a bleeding prevention. In addition, they have a strong resistance to alkali and ultraviolet exposure, and thus they may refer to have a durability.

On the other hand, the nylon fiber yarns generated from crushed tires were not harmful as high quality materials and also are raw materials having a good durability and tensile property. As such, they could be used in many ways. However, using them as raw materials has not yet been developed and thus is simply incinerated. The issues of environmental problems and processing costs have come to the fore.

### DISCLOSURE OF THE INVENTION

### Technical Problem

Thus, the present invention has been designed in order to resolve the problems encountered with prior arts as mentioned above. The purpose of the present invention is to provide a solidifying agent composition for soil blocks which allow for the utilization of waste resources and prevention of environmental contamination, as well as for excellent finishing performance, tensile strength, impact resistance, adhesive properties and resistance to alkali or ultraviolet exposure.

### Technical Solution

In order to accomplish the above mentioned purpose, the present invention provides a solidifying agent composition for soil blocks comprising 15˜35% by weights of KCl, 20˜38% by weights of MgCl₂, 20˜38% by weights of NaCl, 10˜25% by weights of Cl₂, 3˜10% by weights of Na₂SO₄, 2˜8% by weights of NaP₃O₁₀ and 1˜20% by weights of fiber yarns.

The fiber yarns used therein are preferably fiber yarns generated from crushed tires.

The fiber yarns used therein are more preferably nylon fibers with a length less than 3 mm.

### Advantageous Effects

The solidifying agent composition according to the present invention can be applied to the preparation of soil blocks or placed in construction sites, which allow for the utilization of waste resources and the prevention of environmental contamination, as well as for excellent finishing performance, tensile strength, impact resistance, adhesive properties and resistance to alkali or ultraviolet exposure.

### BEST MODE FOR CARRYING OUT THE INVENTION

Hereinafter, the present invention is described in more detail.

The present invention provides a solidifying agent composition for soil blocks comprising 15˜35% by weights of KCl, 20˜38% by weighs of MgCl₂, 20˜38% by weights of NaCl, 10˜25% by weights of Cl₂, 3˜10% by weights of Na₂SO₄, 2˜8% by weights of NaP₃O₁₀ and 1˜20% by weights of fiber yarns.

Among them, the components except for the fiber yarns are those used as the components of conventional solidifying agents. For the solidifying agent composition according to the present invention, it is particularly preferable that the components used are contained within the above mentioned weight range.

The fiber yarns are preferably the fiber yarns generated from crushed tires. Most preferably, the fiber yarns are nylon fibers with a length less than 3 mm, generated from crushed tires.

The fibers yarns generated from crushed tires are preferably nylon materials. They are collected into fiber patterns which are shredded with a length of 5˜20 mm through a first breaking, a second crushing and a third crushing. The resulting fiber yarns are crushed with a length less than 3 mm in order to completely separate from tire rubber in a crushing machine.

The fiber years used in the present invention are dispersed and combined. As such, no agglomeration phenomenon occurs and no hair exposure is made on their installation surface. Also, they have an excellent finishing performance as well as excellent tensile strength and impact resistance. Further, since the fibers themselves have about 4% of absorption rate, the adhesion force with cements is increased and they are effective in a bleeding prevention. In addition, they have a strong resistance to alkali and ultraviolet exposure and thus may refer to have a durability.

In one preferred embodiment, the solidifying agent composition according to the present invention can be mixed and furnished in compliance with the mixing project of soils according to its usage which are applied to the preparation of soil blocks and to construction site.

In one embodiment, the components used are uniformly dispersed and mixed with machines so as not to occur an agglomeration phenomenon between fiber yarns during their mixing. When the mixture is put in bag in compliance with the mixing of soil, there are advantages that a block is produced by reducing one step during in construction site.

In another preferred embodiment, in the course of mixing soil, it is crucial to uniformly disperse and mix the fiber yarns generated from crushed tires. Super chopper can be used to mix with soils while dispersing the soils and shredding the fibers.

The preferred mixing ratio of the solidifying agent composition of the present invention with the soil is not particularly limited, and it can be properly adjusted according to the use thereof. As one preferred embodiment, 1 m³ of a soil can be applied to 0.01˜10 cm³ of a fiber.

The solidifying agent composition according to the present invention can be applied to a cast-in-place, a second product and a dry mortar. It can be applied to the preparation of soil blocks and various finishing materials of wall surface for packaging a trail and a roadway such as a street and a sidewall, and flooring materials for a building and a parking lot.

### Best Mode for Carrying out Invention

Hereinafter, the present invention is described in more detail with reference to examples. However, the following examples are intended to illustrate the invention, and the scope of the invention is not limited to these examples. The examples can be properly corrected and modified by a person skilled in the art within the scope of the present invention.

### Examples

### 1. Preparation of the Solidifying Agent Composition

20% by weight of KCl, 30% by weight of MgCl₂, 30% by weight of NaCl, 10% by weight of Cl₂, 3% by weight of Na₂SO₄, 2% by weight of NaP₃O₁₀ and 5% by weight of fiber yarns were mixed to prepare the desired solidifying agent composition.

### 2. Preparation of Soil Blocks

1% by weight of the above solidifying agent composition, 15% by weight of Portland cement and 84% by weight of sandy soil were mixed to prepare 5×8×15 cm of soil block.

### 3. Characteristic of Soil Blocks

The soil blocks prepared thus have removed the active ingredients of organisms which have absorbed Ca ion to disturb the hydration reaction, thus increasing the density of soil. Also, the soil blocks have facilitated a linkage between soil particles which were excluded according to the penetration of the composition made of a moisture, an air, an organism and the like disturbing the agglomeration effects of fiber yearns. Further, it has been confirmed that, due to the mixing of fiber years, no hair exposure was made on the surface and thus their finishing performance as well as tensile strength, impact resistance and adhesion force were superior to conventional soil blocks.

What is claimed is:

1. A solidifying agent composition for soil blocks and in-site construction comprising 15˜35% by weights of KCl, 20˜38% by weighs of MgCl₂, 20˜38% by weights of NaCl, 10˜25% by weights of Cl₂, 3˜10% by weights of Na₂SO₄, 2˜8% by weights of NaP₃O₁₀ and 1˜20% by weights of fiber yarns.

2. The composition as claimed in claim 1 wherein the fiber yarns are fiber yarns generated from crushed tires.

3. The composition as claimed in claim 2 wherein the fiber yarns are nylon fibers with a length less than 3 mm.
